(19) United States
(12) Patent Application Publication
(10) Pub. No.: US 2022/0019833 A1
(43) Pub. Date: Jan. 20, 2022

(54) INFORMATION PROCESSING APPARATUS, INFORMATION PROCESSING METHOD, AND RECORDING MEDIUM

(71) Applicant: Hiroyuki Sakuyama, Tokyo (JP)

(72) Inventor: Hiroyuki Sakuyama, Tokyo (JP)

(73) Assignee: Ricoh Company, Ltd., Tokyo (JP)

(21) Appl. No.: 17/305,407

(22) Filed: Jul. 7, 2021

(30) Foreign Application Priority Data
Jul. 15, 2020 (JP) 2020-121135

(51) Int. Cl. G06K 9/34; H04N 1/00; G06K 9/32

(52) U.S. Cl. CPC G06K 9/344; H04N 1/00331; G06K 2209/01; G06K 9/3241; G06K 9/325

(57) ABSTRACT

An information processing apparatus includes circuitry to: recognize a plurality of characters in image data; generate one or more words from a string of the plurality of characters; determine, for each word that is generated, a character color to be used for each of one or more characters in the word; and output a file of text data containing the one or more words, each word consisting of the one or more characters having the character color that is determined.

### CROSS-REFERENCE TO RELATED APPLICATIONS

This patent application is based on and claims priority pursuant to 35 U.S.C. § 119(a) to Japanese Patent Application No. 2020-121135, filed on Jul. 15, 2020, in the Japan Patent Office, the entire disclosure of which is hereby incorporated by reference herein.

### BACKGROUND

### Technical Field

The present invention relates to an information processing apparatus, an information processing method, and a recording medium.

### Related Art

According to the related art, a paper document may be scanned into image data, and character recognition processing such as OCR processing may be applied to such image data to convert the image data into a file such as in Office Open XML Document format. In this way, the paper document can be converted into a text data file, which may be edited by a user using a word processor installed on a personal computer.

Sometimes, characters to be recognized have colors. In such case, if colors of characters are determined by character basis, not word basis, it may be difficult for the user to recognize an erroneously recognized character.

### SUMMARY

Example embodiments include an information processing apparatus including circuitry to: recognize a plurality of characters in image data; generate one or more words from a string of the plurality of characters; determine, for each word that is generated, a character color to be used for each of one or more characters in the word; and output a file of text data containing the one or more words, each word consisting of the one or more characters having the character color that is determined.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a hardware configuration of a system according to an embodiment;

FIG. 2 is a schematic block diagram illustrating a hardware configuration of an information processing apparatus in the system according to the embodiment;

FIG. 3 is a schematic block diagram illustrating functions implemented by software installed at the information processing apparatus according to the embodiment;

FIG. 4 is a flowchart illustrating processing of outputting a text file, performed by the information processing apparatus, according to the embodiment;

FIG. 5 is a diagram illustrating character recognition processing according to the embodiment;

FIG. 6 is a diagram for explaining determination of word certainty factor according to the embodiment;

FIG. 7 is a flowchart illustrating color setting processing, performed by the information processing apparatus, according to the embodiment;

FIG. 8 is a diagram illustrating example text data to which color setting processing is applied, according to the embodiment; and

FIG. 9 is a diagram illustrating example text data to which color setting processing is applied, according to the embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

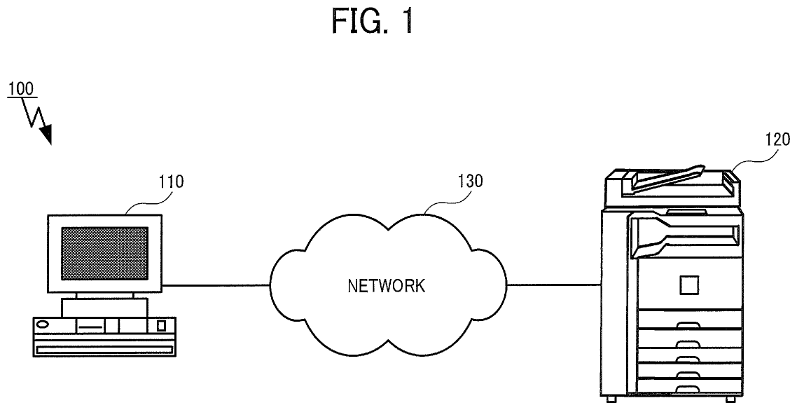

FIG. 1 is a schematic diagram illustrating a configuration of a system 100 according to this embodiment. FIG. 1 illustrates, as an example, an environment in which an information processing apparatus 110 and a Multi-Function Peripheral (MFP) 120 are connected via a network 130 such as the Internet or a LAN. The information processing apparatus 110 or the MFP 120 may be connected to the network 130 by any means, such as wired or wireless.

The information processing apparatus 110 may be a personal computer, for example. The information processing apparatus 110 is able to perform processing such as transmission of a print job to the MFP 120, acquisition of an image scanned by the MFP 120, conversion of the scanned image into a text file, display of the text file, and editing of contents in the text file.

The MFP 120 is an example of an image processing apparatus, which prints an image based on a print job or scans paper document into electronic file, for example. In another embodiment, the MFP 120 may be configured as an information processing apparatus. For example, the MFP 120 may process the scanned image and convert the character strings in the image into text file.

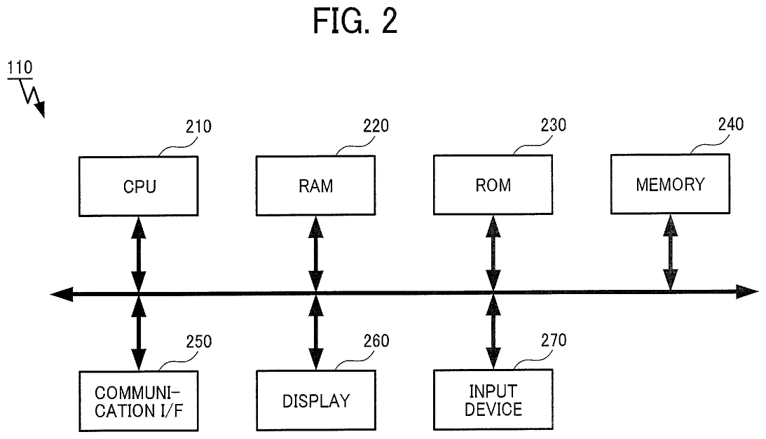

Next, a hardware configuration of the information processing apparatus 110 will be described. FIG. 2 is a diagram illustrating a hardware configuration of the information processing apparatus 110 according to the present embodiment. The information processing apparatus 110 includes a central processing unit (CPU) 210, a random access memory (RAM) 220, a read only memory (ROM) 230, a memory 240, a communication I/F 250, a display 260, and an input device 270, connected with each other via a bus.

The CPU 210 executes a program for controlling operation of the information processing apparatus 110 to perform various processing. The RAM 220 is a volatile memory functioning as an area for deploying a program executed by the CPU 210, and is used for storing or expanding programs and data. The ROM 230 is a non-volatile memory for storing such as programs and firmware to be executed by the CPU 210.

The memory 240 is a readable and writable non-volatile memory that stores operating system (OS) for operating the information processing apparatus 110, various software, setting information, or various data. Examples of the memory 240 include a Hard Disk Drive (HDD) and a Solid State Drive (SSD).

The communication I/F 250 connects the MFP 120 and the network 130, and enables the information processing apparatus 110 to communicate with other device via the network 130. Communication via the network 130 may be either wired communication or wireless communication, and various data can be transmitted and received using a predetermined communication protocol such as TCP/IP.

The display 260, which may be implemented by a liquid crystal display (LCD), displays various data, an operating state of the information processing apparatus 110, etc. to the user. The input device 270, which may be implemented by a keyboard or a mouse, allows the user to operate the information processing apparatus 110. The display 260 and the input device 270 may be separate devices, or may be integrated into one device as in the case of a touch panel display.

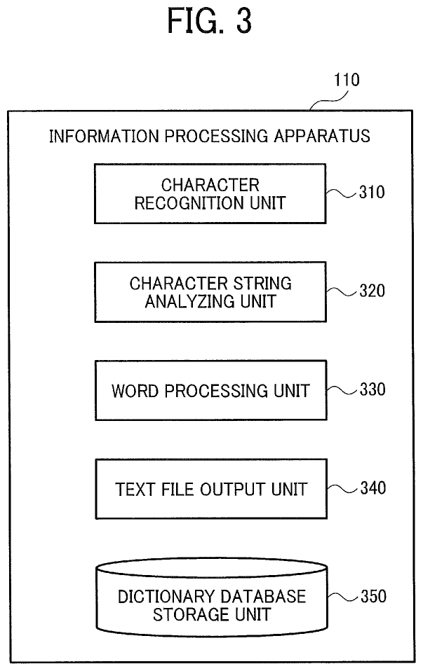

The hardware configuration of the information processing apparatus 110 of the present embodiment has been described above. Next, functional units, executed by hardware of the information processing apparatus 110, will be described with reference to FIG. 3, according to the embodiment.

FIG. 3 is a schematic block diagram illustrating functions implemented by software installed at the information processing apparatus 110 according to the present embodiment. The information processing apparatus 110 according to the present embodiment includes various modules, such as a character recognition unit 310, a character string analyzing unit 320, a word processing unit 330, a text file output unit 340, and a dictionary database storage unit 350.

The character recognition unit 310 performs optical character recognition (OCR) processing on image data to recognize characters included in image data. The image data (or referred to as image) subjected to character recognition is not particularly limited. Examples of such image include an image scanned by such as the MFP 120, an image captured by a camera, and an image drawn on a touch panel display. The character recognition unit 310 can recognize each character based on a language rule such as a position, a size, and a character type of the character (hereinafter, may be simply referred to as a “rule”). The character recognition unit 310 of the present embodiment further calculates a certainty factor (hereinafter, referred to as “character certainty factor”) indicating the degree of certainty in character recognition for each recognized character.

The character string analyzing unit 320 analyzes a character string of a plurality of characters recognized by the character recognition unit 310. The character string analyzing unit 320 segments the character string into one or more meaningful words (hereinafter referred to as “wordization” or generation of word) by performing morphological analysis, for example. In addition, the character string analyzing unit 320 of the present embodiment generates a word by comprehensively determining elements using rules or combinations.

The word processing unit 330 determines a character color to be used, when converting a word generated by the character string analyzing unit 320 into text data. The word processing unit 330 sets a character color based on, for example, whether or not the word generated by the character string analyzing unit 320 is a word registered in the dictionary database storage unit 350 described later (hereinafter, referred to as a “registered word”), and a character certainty factor of characters constituting the word.

The text file output unit 340 converts characters included in an image to be converted into text data, and outputs the text data as a text file in the Office Open XML Document format. The text file output by the text file output unit 340 includes text data converted from a character string, with the character color set by the word processing unit 330. The text file output by the text file output unit 340 may be checked, for example, by the user for text re-editing.

The dictionary database storage unit 350 stores various data in a dictionary database on the memory 240. The dictionary database of the present embodiment stores one or more words that are previously registered, each of which is replaceable with the word generated thorough character recognition. In the present embodiment, to save a storage capacity of the dictionary database, the number of registered words stored in the dictionary database may be reduced, for example, by allowing only a certain part of speech, or allowing words with less number of characters. For example, the dictionary database may be configured to store only nouns of three characters or more and five characters or less as registered word.

The dictionary database according to the present embodiment may be generated by machine learning. For example, a dictionary database is not necessarily used, if keywords that may be included in a recognized character string and registered words that are conversion candidates are classified by machine learning.

In the present disclosure, machine learning is a technique that enables a computer to acquire human-like learning ability. Machine learning refers to a technology in which a computer autonomously generates an algorithm required for determination such as data identification from learning data loaded in advance, and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

While the memory 240 stores the dictionary database, the dictionary database may be stored in any desired memory, for example, on a network, as long as it is accessible from the information processing apparatus 110.

The software block described above referring to FIG. 3 corresponds to functional units, implemented by the CPU 210 executing a program of the present embodiment to operate each hardware of the information processing apparatus 110. In any one of the above-described embodiments, all of the above-described functional units of the information processing apparatus 110 may be implemented by software, hardware, or a combination of software and hardware.

Further, all of the above-described functional units do not necessarily have to be included in the information processing apparatus 110 as illustrated in FIG. 3. For example, in another embodiment, any one of the above-described functional units may be implemented by the information processing apparatus 110 and the MFP 120 that operate in cooperation. In another example, the MFP 120 may function as the information processing apparatus 110 of FIG. 3.

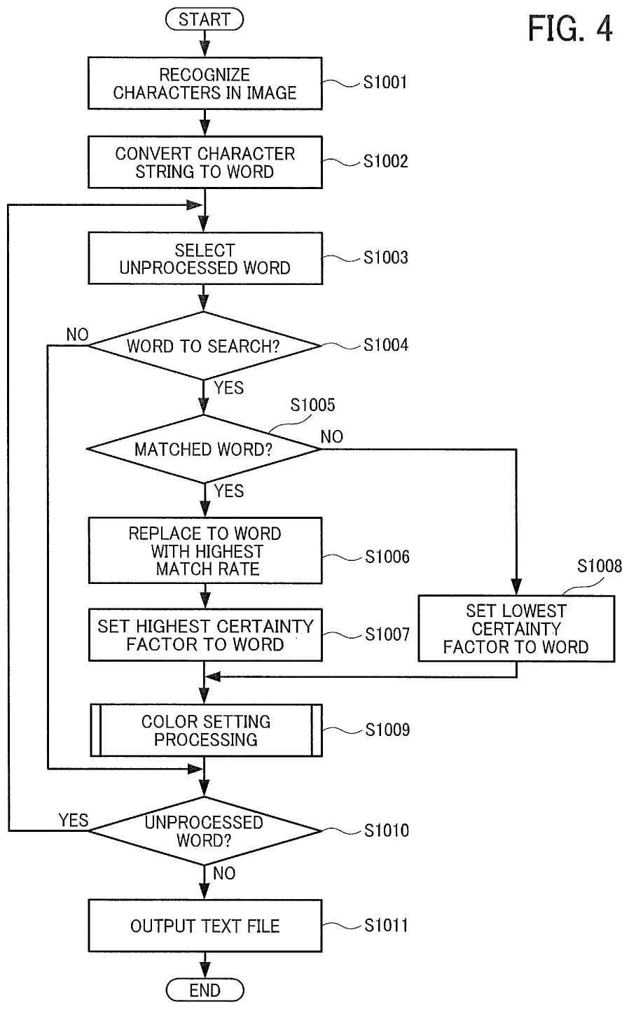

Next, referring to FIG. 4, processing executed by the information processing apparatus 110 will be described according to the embodiment. FIG. 4 is a flowchart illustrating processing of outputting a text file, performed by the information processing apparatus 110, according to the embodiment.

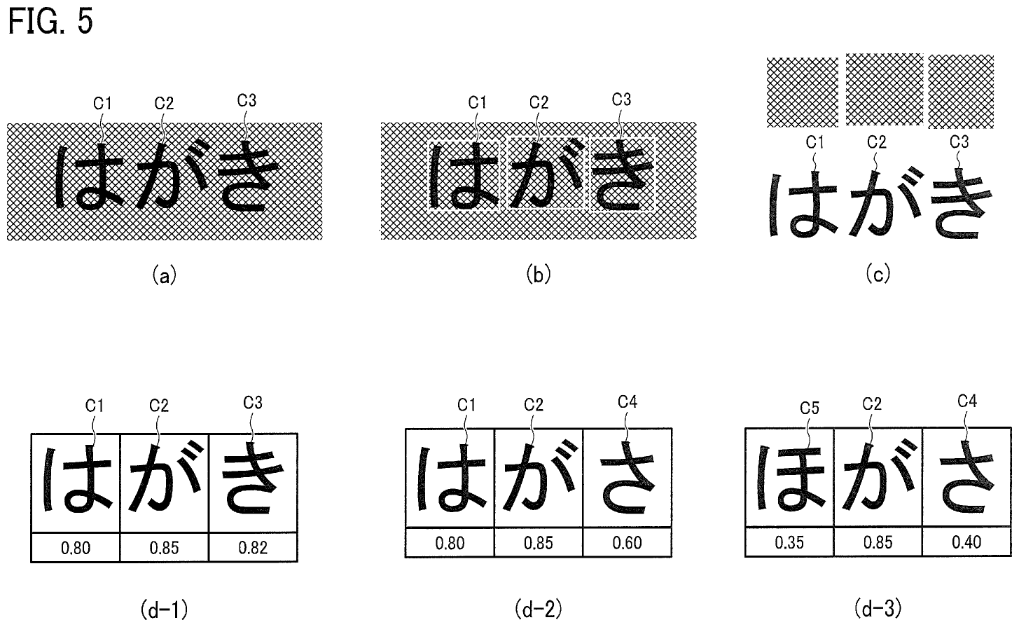

The information processing apparatus 110 of this embodiment starts processing for outputting a text file, as illustrated in FIG. 4. At S1001, the character recognition unit 310 recognizes one or more characters in the image. At S1001, in addition to performing character recognition, the character recognition unit 310 calculates a character certainty factor of each character. Referring now to FIG. 5., character recognition processing is described according to the embodiment. FIG. 5 is a diagram illustrating character recognition processing according to the present embodiment.

(a) of FIG. 5 illustrates an example image to be converted. In the following description, as illustrated in (a) of FIG. 5, it is assumed that an image including black characters C1, C2, and C3 (“postcard” in Japanese) on a dark background is converted into a text file. When the conversion target image of (a) of FIG. 5 is input, the character recognition unit 310 extracts, from the image, rectangles (referred to as “character rectangles”) circumscribing characters C1, C2, and C3, respectively, as illustrated in (b) of FIG. 5.

After extracting the character rectangles, the character recognition unit 310 separates pixels belonging to the characters (character pixels) from pixels belonging to the background (background pixels) as illustrated in (c) of FIG. 5. The upper part of (c) of FIG. 5 illustrates the background pixels separated from corresponding character rectangles. Here, it is assumed that color of each original character pixel is converted into the same color as the background color. The lower part of (c) of FIG. 5 illustrates the character pixels (C1, C2, and C3), defined by the character rectangles.

The character recognition unit 310 recognizes characters in the character pixels C1, C2, and C3, as illustrated in the lower part of (c) of FIG. 5. In addition, the character recognition unit 310 calculates the character certainty factor of each character, while performing character recognition. The character certainty factor indicates a probability of correctly recognizing a character, and is expressed as a value between 0 and 1. Higher the character certainty factor, the probability of correct character recognition increases. The character certainty factor of the present embodiment may be calculated using, for example, Dempster-Shafer probability theory using information such as whether or not the character is suitable to the rule as evidence. Referring to FIG. 5, (d-1) to (d-3) illustrate examples of a character recognition result and a calculated character certainty factor.

(d-1) of FIG. 5 illustrates an example in which the characters C1, C2, and C3 are correctly recognized from the character pixels C1, C2, and C3. In the example (d-1) of FIG. 5, the character certainty factor of C1 is 0.80, the character certainty factor of C2 is 0.85, and the character certainty factor of C3 is 0.82. The character certainty factor of each character illustrated in (d-1) of FIG. 5 is calculated to have a relatively high value because the characters C1, C2, and C3 are all correctly recognized from the character pixels C1, C2, and C3.

(d-2) of FIG. 5 illustrates an example in which the characters C1, C3, and C4 are recognized from the character pixels C1, C2, and C3. In the example (d-2) of FIG. 5, the character certainty factor of C1 is 0.80, the character certainty factor of C2 is 0.85, and the character certainty factor of C4 is 0.60. In the example of (d-2) of FIG. 5, the characters C1, C2, and C4 are recognized from the character pixels C1, C2, and C3. That is, the character certainty factors of C1 and C2 both have relatively high values, while the character certainty factor of C4 (that is incorrectly recognized) has a relatively low value.

(d-3) of FIG. 5 illustrates an example in which the characters C5, C2, and C4 are recognized from the character pixels C1, C2, and C3. In the example of (d-3) of FIG. 5, the character certainty factor of C5 is 0.35, the character certainty factor of C2 is 0.85, and the character certainty factor of C4 is 0.40. In the example of (d-3) of FIG. 5, the characters C5, C2, and C4 are recognized from the character pixels C1, C2, and C3. That is, the character certainty factor of C2 has a relatively high value, while the character certainty factors of C5 and C4 (that are incorrectly recognized) have relatively low values.

The above-described method for character recognition processing is not particularly limited, such that any known method may be used such as image area separation or pattern matching.

The description returns to FIG. 4. After recognizing the characters at S1001, at S1002, the character string analyzing unit 320 converts a character string of the plurality of characters that is recognized into one or more words. The word generation at S1002 can be performed using, for example, morphological analysis. The one or more words generated at S1002 may be temporarily stored in the memory 240.

After S1003, the word processing unit 330 performs processing to convert each generated word into text data. At S1003, the word processing unit 330 selects an unprocessed word among the plurality of words that are recognized. In the subsequent step S1004, the processing branches depending on whether or not the selected unprocessed word is a search target word. In this example, determination of whether or not the word is to be searched is based on, for example, whether the word is a predetermined part of speech or the word has the number of characters less than a predetermined value. Since search is not performed for the word that is determined to be not the search target, word conversion processing can be efficient. For example, as described above, the word not to be the search target may be a word that is not registered in the dictionary database. When the acquired word is not a search target (NO), the operation proceeds to S1010. The processing of S1010 will be described later in detail. When the acquired word is a search target (YES), the operation proceeds to S1005.

At S1005, the word processing unit 330 searches the dictionary database for the search target word. The processing branches depending on whether or not the registered word that matches the search target word is stored in the dictionary database. In this example, when probability indicating the degree of match between the characters of the search target word and the characters of the registered word (character match rate) is higher than a threshold that is preset, it is determined that the registered word matches the search target word. In the following examples, the threshold is set to 60%. When the character match rate is higher than the threshold, it is determined that the word made up of such characters matches the registered word.

When there is at least one registered word stored in the dictionary database that matches the search target word at S1005 (YES), the operation proceeds to S1006. At S1006, the word processing unit 330 extracts a registered word having the highest match rate with the word being processed (search target word), from among registered words stored in the dictionary database, and replaces the word being processed with the extracted registered word. At S1007, the word processing unit 330 sets the certainty factor (hereinafter referred to as “word certainty factor”) indicating the degree of certainty of the search target word, to a value of the highest character certainty factor from among the character certainty factors of the characters constituting the search target word.

When there is no registered word stored in the dictionary database that matches the search target word at S1005 (NO), the operation proceeds to S1008. At S1008, the word processing unit 330 sets the word certainty factor of the search target word to a value of the lowest character certainty factor from among the character certainty factors of the characters constituting the search target word.

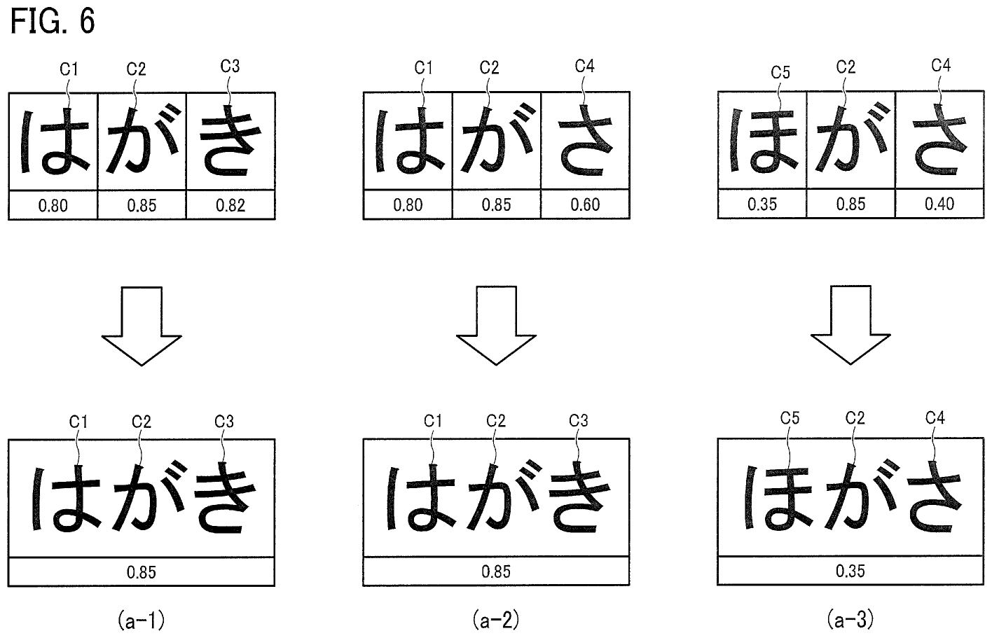

Referring now to FIG. 6, setting of the word certainty factor at S1007 and S1008 will be described according to an example. FIG. 6 is a diagram for explaining determination of word certainty factor in the present embodiment. FIG. 6 illustrates an example in which characters recognized as (d-1) to (d-3) of FIG. 5 are searched through the dictionary database, and set with word certainty factors as indicated by (a-1) to (a-3) of FIG. 6. In this example illustrated in FIG. 6, it is assumed that word that consists of characters C1, C2, and C3 (“postcard” in Japanese) is stored as a registered word in the dictionary database.

First, the example case (a-1) of FIG. 6 will be described. In this case, a character string including characters C1, C2, and C3 as indicated by (d-1) in FIG. 5 is set as a search target. As described above, the dictionary database stores the registered word that consists of characters C1, C2, and C3. Since the character string of characters C1, C2, and C3 matches the registered word of characters C1, C2, and C3, as all three characters in the word match, it is determined that the character match rate is 100%. Since the character match rate exceeds 60%, which is the threshold of the character match rate, the character string of characters C1, C2, and C3 in the search target word is replaced with the character string of characters C1, C2, and C3 in the matched registered word. Further, 0.85 of the character C2, which is the highest character certainty factor of the character certainty factors of all characters C1, C2, and C3, is set as a word certainty factor of the word.

Next, the example case (a-2) of FIG. 6 will be described. In this case, a character string including characters C1, C2, and C4 as indicated by (d-2) in FIG. 5 is set as a search target. As described above, the dictionary database stores the registered word that consists of characters C1, C2, and C3. Based on comparison between the character string of characters C1, C2, and C4 and the registered word of characters C1, C2, and C3, since two out of three characters in the word match, it is determined that the character match rate is 67%. Since the character match rate exceeds 60%, which is the threshold of the character match rate, the character string of characters C1, C2, and C4 in the search target word is replaced with the character string of characters C1, C2, and C3 in the matched registered word. Further, 0.85 of the character C2, which is the highest character certainty factor of the character certainty factors of all characters C1, C2, and C4, is set as a word certainty factor of the word.

Next, the example case (a-3) of FIG. 6 will be described. In this case, a character string including characters C5, C2, and C4 as indicated by (d-3) in FIG. 5 is set as a search target. As described above, the dictionary database stores the registered word that consists of characters C1, C2, and C3. Based on comparison between the character string of characters C5, C2, and C4 and the registered word of characters C1, C2, and C3, since one out of three characters in the word matches, it is determined that the character match rate is 33%. Since the character match rate is less than 60%, which is the threshold of the character match rate, the character string of characters C5, C2, and C4 in the search target word is not replaced with the character string of characters C1, C2, and C3 in the matched registered word. Further, 0.35 of the character C5, which is the lowest character certainty factor of the character certainty factors of all characters C5, C2, and C4, is set as a word certainty factor of the word.

When a plurality of registered words having the same character match rate are extracted as a result of the search, the search target word may be replaced with the registered word having the highest sum of the character certainty factors, for example.

The description is returned to FIG. 4. At S1007, the word processing unit 330 sets the word certainty factor having the highest value as described in (a-1) and (a-2) of FIG. 6. At S1008, the word processing unit 330 sets the word certainty factor having the lowest value as described in (a-3) of FIG. 6. After the word certainty factor is set at S1007 or S1008, the word processing unit 330 performs color setting processing on the word to be converted into text at S1009. At S1009, the word processing unit 330 sets a character color to each word according to the word certainty factor. The details of color setting processing at S1009 will be described later.

After the color setting process at S1009 or after determining that the word acquired at S1004 is not a search target, the word processing unit 330 performs processing of S1010. At S1010, processing branches depending on whether or not there is an unprocessed word. When there is an unprocessed word (YES), the operation returns to S1003, and the above-described processing is repeated until there is no unprocessed word. When there is no unprocessed word (NO), the operation proceeds to S1011.

At S1011, the text file output unit 340 outputs a text file, obtained by converting characters included in the image to be converted into text data of characters recognized by the character recognition unit 310. The character color of the text file output at S1011 may be the color set at S1009. The information processing apparatus 110 then ends processing to output the text file.

Through processing of FIG. 4, the information processing apparatus 110 can convert the image into text data in which a character color is set in each unit of word. When there is an erroneous character recognition, a reader as a user can easily grasp the erroneous recognition.

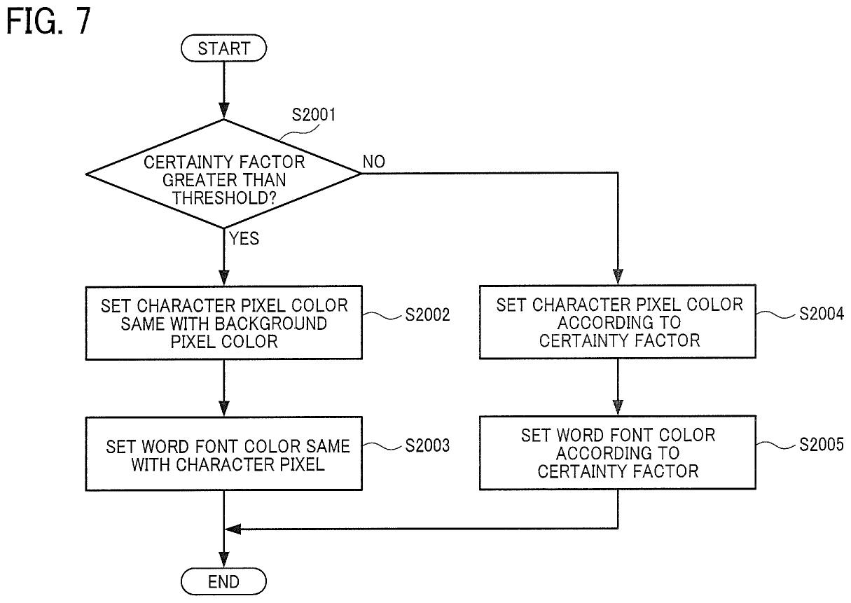

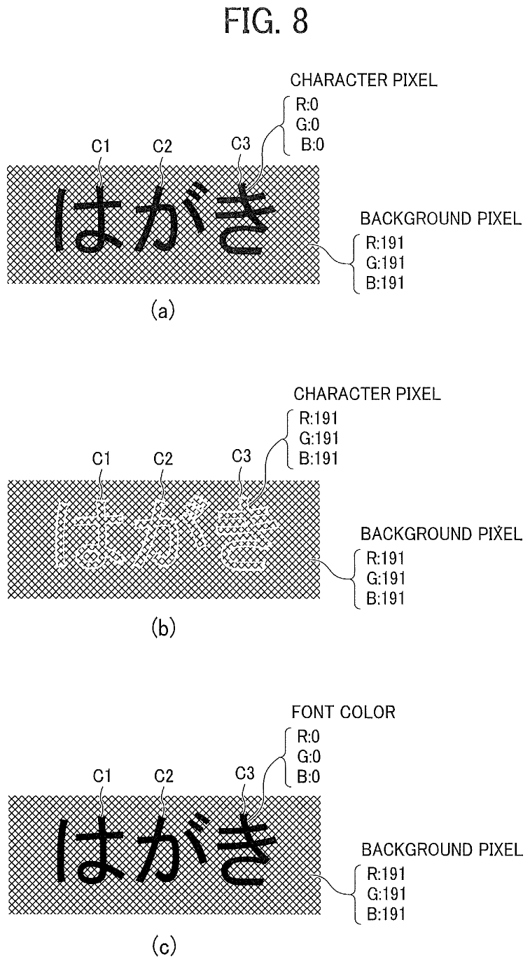

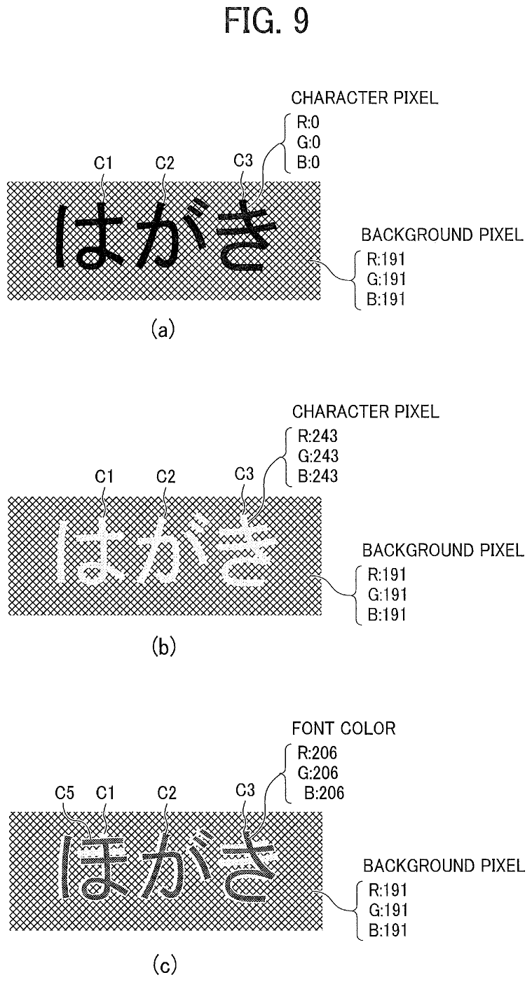

The processing to output a text file performed by the information processing apparatus 110 according to the present embodiment has been described above. Referring now to FIG. 7, color setting processing (S1009), performed in the process of generating the text file, is described according to the embodiment. FIG. 7 is a flowchart illustrating color setting processing, performed by the word processing unit 330, according to the embodiment. The processing of FIG. 7 is described, while referring to FIGS. 8 and 9 as appropriate. FIGS. 8 and 9 are diagrams illustrating an example of text data on which the color setting of the present embodiment has been performed.

The word processing unit 330 starts color setting processing of FIG. 7. Specifically, the word processing unit 330 of the present embodiment starts color setting processing, triggered by S1009 of FIG. 4. At S2001, the word processing unit 330 determines whether or not the word certainty factor of the word to be processed (that is, the search target word) is greater than the threshold. When the word certainty factor is greater than the threshold (YES), the operation proceeds to S2002. When the word certainty factor is equal to or less than the threshold (NO), the operation proceeds to S2004.

First, the example case in which the word certainty factor is greater than the threshold (YES at S2001) will be described. In this case, at S2002, the word processing unit 330 sets a color of character pixels of the word in the image to the same color as the background color. At S2003, the word processing unit 330 sets a font color of the word to the same color as the character pixel in the image. The processing of S2002 and S2003 may be performed in an order reverse of the order illustrated in FIG. 7 or may be performed in parallel. The word processing unit 330 then ends the color setting processing. When the color setting processing ends, the information processing apparatus 110 proceeds to the processing of S1010 in FIG. 4.

Referring to FIG. 8, processing to set a color is described according to this example. The RGB values illustrated in FIG. 8 are illustrated for the descriptive purpose, and such values are not to be included as content of the image to be converted or text file to be output.

(a) of FIG. 8 illustrates an example image to be converted. The image includes characters C1, C2, and C3 (“postcard” in Japanese), with character pixel color of R=0, G=0, and B=0, and a background image with background pixel color of R=191, G=191, and B=191. It is assumed that the image of (a) of FIG. 8 is output as a text file, and the word certainty factor of characters is greater than the threshold.

In such case, at S2002 of FIG. 7, the word processing unit 330 sets the color of each of the character pixels to the same color as the background pixels. (b) of FIG. 8 illustrates an example in which the color of each of the character pixels is set to the same color as the background pixels. As illustrated in (b) of FIG. 8, the color of each of the character pixels has values, R=191, G=191, and B=191, which are the same as the color of the background pixels. The outlines of the characters in (b) of FIG. 8 are shown for illustrative purposes, and are not to be included as the content of the image to be converted or text file to be output.

At S2003 of FIG. 7, the word processing unit 330 sets the font color of the word to the same color as the character pixels of the image to be converted. Accordingly, the font color of the word that consists of C1, C2, and C3 (“postcard” in Japanese) has values, R=0, G=0, and B=0, which are the same as the colors of the character pixels in (a) of FIG. 8. The text file output unit 340 outputs a text file in the form as illustrated in (c) of FIG. 8, in which the word with the font color set as above is superimposed on the background image of (b) of FIG. 8.

The word processing unit 330 may set a font size of the word to be output to be greater than the original size. Since the font size may be recognized to be small in the process of converting the color of the character pixel, the information processing apparatus 110 can output a text file that can be viewed more naturally by thickening the character as described above.

The description returns to FIG. 7. When the word certainty factor is equal to or less than the threshold (NO) at S2001 of FIG. 7, the operation proceeds to S2004. At S2004, the word processing unit 330 sets the color of each of the character pixels of the word in the image to a color determined by the word certainty factor. In this example, the color of each of the character pixels set according to the word certainty factor can be calculated, for example, using the following equations (1-1) to (1-3).

[Equation 1]

Rr=Rb+(255−Rb)×(1−C)\hat{ }x (1-1)

Gr=Gb+(255−Gb)×(1−C)\hat{ }x (1-2)

Br=Bb+(255−Bb)×(1−C)\hat{ }x (1-3)

Rr, Gr, and Br of the equations (1-1) to (1-3) respectively represent R, G, and B values of color of each of character pixels to be set. In the equations (1-1) to (1-3), Rb, Gb, and Bb respectively represent R, G, and B values of color of each of the background pixels of the original image before conversion. C in the equations (1-1) to (1-3) is a word certainty factor. In the equations (1-1) to (1-3), x represents a weight of the word certainty factor in the color setting process, and typically has a value of about ⅓ to ½.

After S2004, the word processing unit 330 sets the font color of the word to a color corresponding to the word certainty factor of the word at S2005. In this example, the font color set according to the word certainty factor can be calculated, for example, using the following equations (2-1) to (2-3).

[Equation 2]

Rf=Rc+(255−Rc)×(1−C)\hat{ }x (2-1)

Gf=Gc+(255−Gc)×(1−C)\hat{ }x (2-2)

Bf=Bc+(255−Bc)×(1−C)\hat{ }x (2-3)

Rf, Gf, and Bf of the above equations (2-1) to (2-3) respectively represent R, G, and B values of the set font color. In the equations (2-1) to (2-3), Re, Gc, and Bc respectively represent R, G, and B values of color of character pixels of the original image, before conversion. C in the equations (2-1) to (2-3) is a word certainty factor. In the equations (2-1) to (2-3), x represents a weight of the word certainty factor in the color setting process, and typically has a value of about ⅓ to ½.

The processing of S2004 and S2005 may be performed in an order reverse of the order illustrated in FIG. 7 or may be performed in parallel. Further, setting of colors using the above equations (1-1) to (1-3) and equations (2-1) to (2-3) is an example, and colors may be set in various other ways. After S2005, the word processing unit 330 ends the color setting process. When the color setting processing ends, the information processing apparatus 110 proceeds to the processing of S1010 in FIG. 4.

Referring to FIG. 9, processing to set a color is described according to this example. The RGB values illustrated in FIG. 9 are illustrated for the descriptive purpose, and such values are not to be included as content of the image to be converted or text file to be output.

Similarly to (a) of FIG. 8, (a) of FIG. 9 illustrates an example image to be converted. The image includes characters C1, C2, and C3 (“postcard” in Japanese), with character pixel color of R=0, G=0, and B=0, and a background image with background pixel color of R 191, G=191, and B=191. It is assumed that the image of (a) of FIG. 9 is output as a text file, when the word is incorrectly recognized as C5, C2, and C3, and the word certainty factor of characters has a value of 0.35, which is equal to or less than the threshold.

In such a case, at S2004 of FIG. 7, the word processing unit 330 sets the color of each of the character pixels to color corresponding to the word certainty factor using the above equations (1-1) to (1-3). In this example, if the equations (1-1) to (1-3) are applied, the color of each of the character pixels is calculated as R=243, G=243, and B=243. (b) of FIG. 9 illustrates an example in which color of each of the character pixels is set to R=243, G=243, and B=243.

At S2005 of FIG. 7, the word processing unit 330 sets the font color of the word to a color corresponding to the word certainty factor using the above equations (2-1) to (2-3). In this example, when the equations (2-1) to (2-3) are applied, the font color is calculated as R=206, G=206, and B=206. The text file output unit 340 outputs a text file in the form as illustrated in (c) of FIG. 9, in which the word with the font color set as above is superimposed on the background image of (b) of FIG. 9. In the case of text file output having the word certainty factor lower than the threshold, the word is displayed in an unnatural form as illustrated in (c) of FIG. 9. With this look, the reader can easily recognize a word having a high possibility of erroneous recognition.

Through processing described in FIG. 7, the word processing unit 330 determines a color according to the word certainty factor, such that a reader as a user can easily grasp erroneous character recognition.

According to the embodiment described above, an information processing apparatus, an information processing method, and a program, are provided, each of which outputs a file in a manner that erroneous recognition of character can be easily found.

Each function in the exemplary embodiment may be implemented by a program described in C, C++, C# or Java (registered trademark). The program may be provided using any storage medium that is readable by an apparatus, such as a hard disk drive, compact disc (CD) ROM, magneto-optical disc (MO), digital versatile disc (DVD), a flexible disc, erasable programmable read-only memory (EPROM), or electrically erasable PROM. Alternatively, the program may be transmitted via network such that other apparatus can receive it.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), and field programmable gate array (FPGA), and conventional circuit components arranged to perform the recited functions.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

1. An information processing apparatus comprising circuitry configured to:
recognize a plurality of characters in image data;
generate one or more words from a string of the plurality of characters;
determine, for each word that is generated, a character color to be used for each of one or more characters in the word; and
output a file of text data containing the one or more words, each word consisting of the one or more characters having the character color that is determined.

2. The information processing apparatus of claim 1, wherein the circuitry determines, for each word, a character certainty factor of each of one or more characters in the word, the character certainty factor indicating the degree of certainty in character recognition for each character.

3. The information processing apparatus of claim 2, wherein the circuitry determines, for each word, the character color, based on whether at least one word that matches the word that is generated is stored in the database and the character certainty factor of selected one of the one or more characters in the word.

4. The information processing apparatus of claim 1, wherein the one or more words contained in the text data are superimposed on pixels of the recognized plurality of characters in the image data.

5. The information processing apparatus of claim 1, wherein the circuitry converts, for each word, colors of pixels of one or more characters in the word to colors according to the character certainty factor of selected one of the one or more characters in the word.

6. The information processing apparatus of claim 1, wherein
the circuitry determines, for each word that is generated, whether there is at least one word stored in the database that matches the word that is generated,
based on a determination that there is at least one word that matches the word that is generated, the circuitry sets a certainty factor of the word, to a highest character certainty factor of character certainty factors of the characters in the word,
determines whether the certainty factor of the word is greater than a threshold, and
based on a determination that the certainty factor of the word is greater than the threshold, sets colors of one or more characters that consist the word according to pixel colors of the one or more characters in the word.

7. The information processing apparatus of claim 1, wherein
the circuitry determines, for each word, whether there is at least one word stored in the database that matches the word that is generated,
based on a determination that there is no word that matches the word that is generated, the circuitry sets a certainty factor of the word, to a lowest character certainty factor of character certainty factors of the characters in the word,
determines whether the certainty factor of the word is greater than a threshold, and
based on a determination that the certainty factor of the word is equal to or less than the threshold, sets colors of one or more characters that consist the word according to the certainty factor of the word.

8. An information processing method comprising:
recognizing a plurality of characters in image data;
generating one or more words from a string of the plurality of characters;
determining, for each word that is generated, a character color to be used for each of one or more characters in the word; and
outputting a file of text data containing the one or more words, each word consisting of the one or more characters having the character color that is determined.

9. The information processing method of claim 8, further comprising:
determining a character certainty factor of each of one or more characters in the word, the character certainty factor indicating the degree of certainty in character recognition for each character.

10. The information processing method of claim 9, further comprising:
determining, for each word, the character color based on whether at least one word that matches the word that is generated is stored in the database and the character certainty factor of selected one of the one or more characters in the word.

11. The information processing method of claim 8, further comprising:
superimposing the one or more words contained in the text data on pixels of the recognized plurality of characters in the image data.

12. The information processing method of claim 8, further comprising:
converting, for each word, colors of pixels of one or more characters in the word to colors according to the character certainty factor of selected one of the one or more characters in the word.

13. The information processing method of claim 8, further comprising:
determining, for each word that is generated, whether there is at least one word stored in the database that matches the word that is generated;
based on a determination that there is at least one word that matches the word that is generated, setting a certainty factor of the word, to a highest character certainty factor of character certainty factors of the characters in the word;
determining whether the certainty factor of the word is greater than a threshold; and
based on a determination that the certainty factor of the word is greater than the threshold, setting colors of one or more characters that consist the word according to pixel colors of the one or more characters in the word.

14. The information processing method of claim 8, further comprising:
determining, for each word that is generated, whether there is at least one word stored in the database that matches the word that is generated;
based on a determination that there is no word that matches the word, setting a certainty factor of the word, to a lowest character certainty factor of character certainty factors of the characters in the word;
determining whether the certainty factor of the word is greater than a threshold; and
based on a determination that the certainty factor of the word is equal to or less than the threshold, setting colors of one or more characters that consist the word according to the certainty factor of the word.

15. A non-transitory recording medium storing a plurality of instructions which, when executed by one or more processors, cause the processors to perform an information processing method comprising:
recognizing a plurality of characters in image data;
generating one or more words from a string of the plurality of characters;
determining, for each word that is generated, a character color to be used for each of one or more characters in the word; and
outputting a file of text data containing the one or more words, each word consisting of the one or more characters having the character color that is determined.
